(19) United States
(12) Patent Application Publication
(10) Pub. No.: US 2008/0059504 A1
(43) Pub. Date: Mar. 6, 2008

(54) Method and system for rendering graphical user interface

(76) Inventors: Jackie Barbetta, Holly Springs, NC (US); Xin Du, Plainsboro, NJ (US); Klaus Sonnenleiter, Franklin Lakes, NJ (US)

Correspondence Address: THELEN REID BROWN RAYSMAN & STEINER LLP, PO BOX 1510, NEW YORK, NY, 10150-1510, US

(21) Appl. No.: 11/292,337

(22) Filed: Nov. 30, 2005

(51) Int. Cl. G06F 3/048; G06F 17/30

(52) U.S. Cl. 707/102; 715/762; 707/E17.009

(57) ABSTRACT

Methods, systems and computer-usable media for storing program code for generating a customized graphical user interface for specified functions using generic base code are described. The methods include the automatic discovery and rendering of graphical user interface elements. User selected component data associated with the specified functions is stored in one or more structured markup language files, user selected style data is stored in one or more style specification files, and a merged file comprising the component data and the style data is generated. The merged file is converted into one or more executable applications for generating the customized graphical user interface by associating the component data contained in the merged file with generic base code.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Computer applications, including applications for rendering graphical user interfaces (GUIs), are created by a software developer or programmer writing source code using a designated programming language (e.g., C++ or Java). Programs, including those used to generate basic elements of GUIs such as text boxes, command buttons and menus, can often require hundreds or thousands of lines of code. After the source code is written, to be usable on a computer, the source code must be converted into a machine-readable format (e.g., object code). A program called a compiler translates the source code into the requisite machine language.

Even the smallest errors by a programmer in writing the source code may prevent the code from compiling and prevent the program from running successfully. In addition, substantial editing may be required to make even minor adjustments to elements of an individual GUI. Further, if a software suite or other group of products or content requires individual GUIs with common elements or themes, any change must be made to each individual GUI, thus multiplying significantly the time required by the computer programmer to effectuate the change and the chance for errors.

Methods such as rapid application development (RAD) and products, such as Microsoft's Visual Basic, have been developed to help simplify the creation of computer programs, and in particular, GUI creation. With RAD tools, programmers visually assemble existing components and attach code to those components to create a new program. Such tools are helpful in decreasing the need to write code. For instance, products such as Microsoft's Visual Basic a programmer is provided with a set of visual objects that represent common functional elements. Programmers select objects, place the object onto a form window, and then the program (e.g., Visual Basic) automatically creates corresponding code to support that object. Other development products exist, such as Borland's JBuilder, Oracle's JDeveloper, and Microsoft's Management Console, which is part of the Microsoft Windows Software Development Kit.

However, existing products, while helpful in some instances by eliminating the need to write code for some standard elements, are limited in their usefulness in so far as providing for only fixed elements, and still requiring code to be written and deployed for non-standard aspects of the GUI, for events which arise from the elements and to delineate relationships between the elements. Such products are code generation tools, where the end result is code which can be edited. Because of this, such products are not accessible to many computer users, such as database managers, but rather are useful only to advanced computer programmers. A programmer must still write and compile a substantial amount of code and will need to learn and will be limited by the syntax and keyword structures of the development tool. Moreover, some existing products are limited to very specific uses or environments.

Thus, there exists a need for a generic-use, auto-rendering GUI engine which avoids the aforementioned disadvantages.

### SUMMARY OF THE INVENTION

In one aspect of the present invention, a method, system and computer usable medium storing program code for generating a customized graphical user interface for specified functions using generic base code is provided. The present invention may be used as an internal user interface tool to facilitate GUI creation and maintenance by less sophisticated computer programmers or computer system personnel. In a preferred embodiment, the present invention includes the automatic discovery and rendering of GUI elements.

In one embodiment, user selected component data associated with the specified functions is stored in one or more structured markup language files; user selected style data is stored in one or more style specification files; and a merged file comprising the component data and the style data is generated. The merged file is converted into one or more executable applications for generating the customized graphical user interface by associating the component data contained in the merged file with generic base code.

In some embodiments, definition data is created which specifies the structure of the one or more structured markup language files. The definition data may be a document type definition or an XML schema definition, for example. Component data may be selected based on the definition data. In one aspect of the present invention, the component data is stored in an XML file, and the style data is stored in an XSLT file.

In some embodiments, the style data in the style specification file is modified to render a different look and layout for the graphical user interface, and in some cases modification to a single style specification file results in corresponding modifications to the look and layout of multiple graphical user interfaces. The merged file, which may be a .jsp file, may be generated using a converter script and XALAN to apply an XSLT file to an XML file. Generating the merged file may also comprise updating a global configuration file.

In some embodiments, a determination is made as to whether to convert the merged file based on access to the customized graphical user interface, and whether a resource within the customized graphical user interface has or has not previously been accessed. The conversion of the merged file into the executable application may be based on a dynamic bean and may be reusable for multiple graphical user interfaces.

In some embodiments, events in the graphical user interface are associated with web service calls by associating the events with specified components.

In some embodiments, the present invention enables the use of standard and customized components with which to generate customized executable applications to avoid a substantial amount of creation and editing of code to generate and run a GUI. One result of implementing the methods and using the systems disclosed is the automated generation of customized GUIs without needing to write additional computer code.

In some embodiments, the present invention enables a single point of testing and development to create elements of the GUI, the GUI rendering method and system of the present invention increases the efficiency, precision and reliability of GUI development while decreasing the cost of such development.

The present invention may, in some cases, facilitate changes, maintenance and modification to GUIs across a spectrum of products or product suites so that changes to all the product GUIs will only need to be made once, thus saving time and money and promoting consistency of GUI appearance. In addition, data from different sources, such as different products within a suite of products, may be easily coordinated into one GUI.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 is a flow chart showing a method of generating a customized graphical user interface for specified functions represented by pre-defined code, in accordance with one embodiment of the present invention;

FIG. 2 is a flow chart showing a method of generating a customized graphical user interface for specified functions represented by pre-defined code, where the customized graphical user interface contains resources that may or may not have been previously accessed, in accordance with one embodiment of the present invention;

FIG. 3 is a block diagram showing components of a system operating according to the method of FIG. 2, in accordance with one embodiment of the present invention; and

FIG. 4 is a block diagram showing further detail of certain components of FIG. 3, in accordance with one embodiment of the present invention.

FIG. 5 is an example of a structured markup language file for use in accordance with one embodiment of the present invention.

FIGS. 6-8 are examples of GUI screen shots in accordance with certain embodiments of the present invention.

### DETAILED DESCRIPTION OF THE PREFERRED EMBODIMENTS

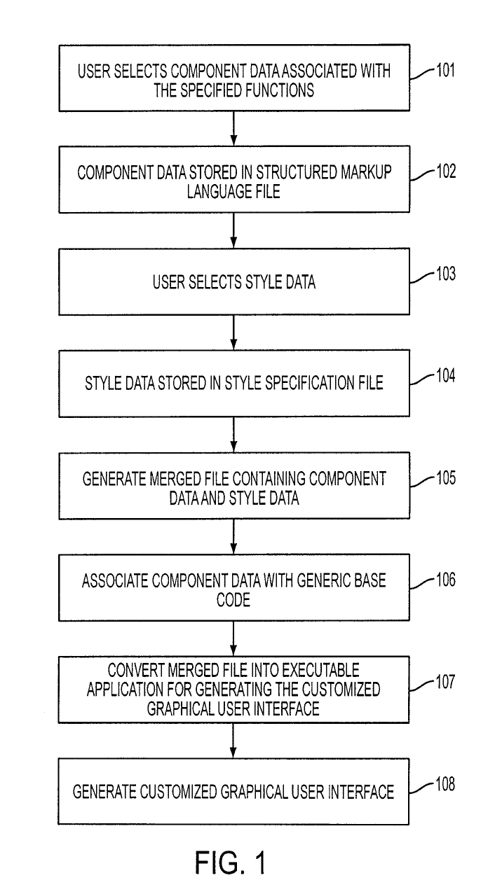

With reference to FIGS. 1 through 4, embodiments of the present invention are shown.

Referring to Fig. 1, one embodiment of a method of dynamically generating a customized graphical user interface for specified functions using generic code is shown. According to the flow diagram of FIG. 1, a method for generating a customized graphical user interface (GUI) comprises a user selecting component data associated with specified functions step 101. The component data comprise computer code to carry out discrete specified functions performed in rendering a GUI. The component data comprises both standard pre-existing components and customized components to extend or provide customized functionality. Standard components currently available, for example, those in the JavaServer Faces library, provide desirable and commonly used functionality, such as mechanisms for different GUI rendering options (e.g., HTML or WML), internationalization support, validation of data and server-side component creation. Customized components-are created to extend or provide additional functionality which may be unique to a particular GUI. Standard and customized components may be reused once created. The components are wrapped within another class to make changes to the underlying technology easier. At step 102, selected component data is stored in a structured markup language file step 102, such as an XML file, SGML file or other file providing similar functionality. The structured markup language file containing the selected component data identifies what elements appear in each GUI and how those elements are rendered. Configuration of the component data in the structured markup language file allows the use of multiple WSDL (Web Services Description Language) files permitting integration of different product information in a single GUI. The WSDL files contain data access and controller information and facilitate initiation of Web services APIs (Application Programming Interfaces). In some embodiments, the GUI rendering engine only reads XML and WSDL files and WSDL API definitions, such that the GUI may be independent of specific versions of products.

At step 103, a user selects style data to be stored in a style specification file step 104. The selection of style data may occur before the creation of the structured markup language file storing the GUI components, and may apply to multiple different such structured markup language files. The style data identifies how different elements in a GUI, such as headers or links, will appear (e.g., fonts, colors). The style specification file operates to transform the structured markup language file into other structured markup language files, and to separate the layout style of the GUI from each GUI definition. In some embodiments, the style specification file is an XSLT file. XSLT is a language for transforming XML documents into other XML documents, and is part of XSL, a stylesheet language for XML. XSLT permits the control of the look and feel of multiple GUIs with one file, and supports numerous types of markup languages (XML, WML, XHTML). Other style specification files may be used, for instance, Tiles, which is part of Struts, from the Apache Software Foundation, or cascading style sheets. The decision as to which type of style specification file to use may be based on a variety of factors, such as compatibility with other aspects of the inventive system, the ability to support transformation of the structured markup file into other forms of markup, and ease of use. For instance, in some embodiments, it may be preferable to store all of the style data in a single file to facilitate reuse by the system and simplify GUI rendering, or to facilitate changes to the style data by having the data centrally located, and in other embodiments, multiple files may be preferred. In some embodiments, when the style data in a single file is used to render multiple GUIs, changes to the style data in that one file results in corresponding changes to each of the multiple GUIs.

Referring still to FIG. 1, the illustrative embodiment comprises generating a merged file 105 containing the component data and the style data. In some embodiments, the merged file is a JavaServer Faces (JSF) .jsp file, which uses JavaServer Faces tags for the JavaServer Faces components rendered. JSF is a Web application framework which permits the assembling of reusable user interface components in a page, connecting the components to an application data source, and associating client-generated events to server-side event handlers. In its standard form, JSF is Java Server Pages (JSP) based and allows for separation of graphics from the components of the GUI. JSF contains built-in functionality such as support for validation, internationalization, state caching and special characters, among other things, and the ability to add plug-ins to easily enhance the functionality (such as by adding a property resolver to identify dynamic properties and an action listener to identify events).

As described more fully below, the component data is associated with generic base code step 106 to convert the merged file into one or more executable applications step 107 to generate the customized GUI step 108.

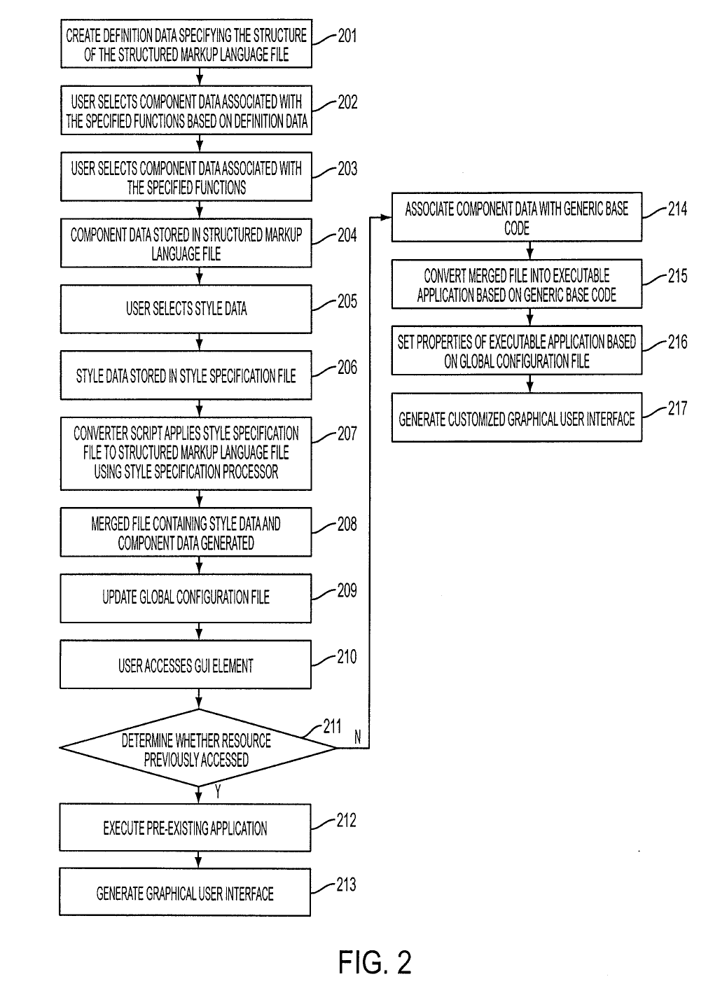

A further detailed illustration of the embodiment of the inventive method as set forth in FIG. 1 is provided with reference to FIG. 2. At step 201, definition data is created for specifying the structure of the structured markup language file. In some embodiments, the definition data comprises a document type definition, or alternatively, an XML schema definition. The definition data includes data needed to render the GUI, such as custom components and their attributes, links to web service descriptors such as WSDL methods, for example, and may vary depending on the specific GUI functionality desired. The selection of component data is, in some embodiments, based on the definition data step 202. Alternatively, the definition data is not created until after customized components are specified. As described in the above embodiment steps 102, 103, 104, the method further includes component data being stored in a structured markup language file step 204, a user selecting style data step 205, and the style data being stored in a style specification file step 206.

At step 207, in some embodiments, a style specification processor or layout manager, comprising a script, which in some embodiments is referred to as converter script, for applying the style specification file to the structured markup file, is used to generate a merged file containing style data and component data step 208. The merged file generated using the converter script is an example of a file that would otherwise have to be written by a programmer but is automatically generated by use of the present invention. Examples of such merged files are provided in the Appendix hereto (newUser.jsp and googleTest.jsp).

The merged file is generated, in one embodiment, using a script to apply an XSLT file to an XML file using XALAN. Certain style specification files may be preferred in some embodiments based on the ability to process more complex transformations from one structured markup language document to another. The method of one embodiment further comprises updating a global configuration file step 209 with information for the GUI to be rendered such as navigation information.

In some embodiments, the method comprises a user accessing a GUI step 210, such as a Web page, and a determination being made as to whether a specific resource within the GUI has previously been accessed step 211, such that the system would determine whether to execute a pre-existing application step 212 or proceed to dynamically generate an executable application steps 214-216 used for rendering a GUI. In some embodiments, the executable applications comprise “beans.” At step 211, if it is determined that a requested resource has previously been accessed, the system re-uses and executes pre-existing applications step 212 to generate the GUI step 213. Alternatively, if the requested resource has not previously been accessed, the system proceeds to dynamically generate an executable application by associating component data with generic base code step 214, converting a merged file comprising component data and style data into a customized executable application based on a generic base code step 215. The properties of the customized executable application are set, in some embodiments, based on a global configuration file step 216. At step 217, the customized GUI is generated using the customized executable applications. The customized executable applications may be re-used when the same resources on the same GUI are accessed at a later time, and may be re-used when the same resources on a different GUI are accessed.

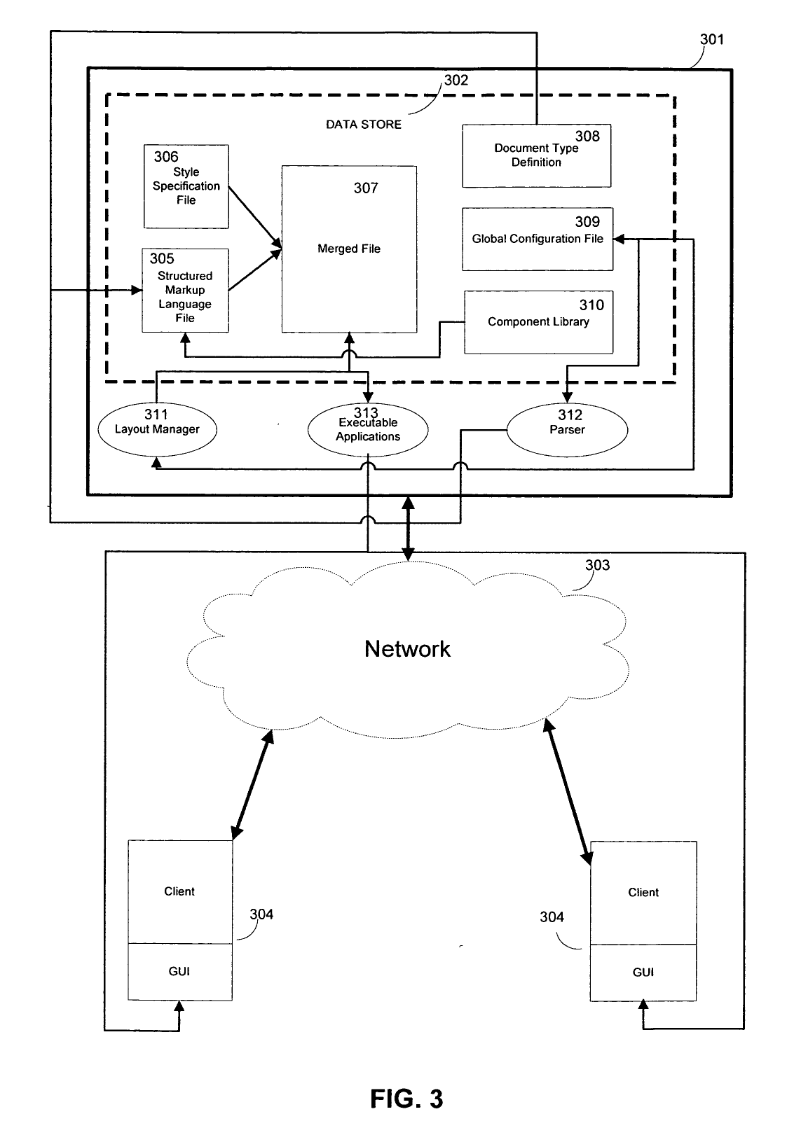

FIG. 3 presents a block diagram of one embodiment of a system according to the present invention. The system includes a server 301, a data store 302, a network 303, and one or more clients and GUIs 304. Within the data store 302 is a structured markup language file for storing user selected component data associated with specified functions 305, a style specification file for storing user selected style data 306 and a merged file containing component data and style data 307. In some embodiments, the system includes a document type definition 308 (created at 201), which may be an XML schema definition or other definition type, for specifying the structure of the structured markup language file 305, which may be an XML file. The system may also include a global configuration file 309 which may contain navigation information about GUIs which will be rendered. Component data may be selected for the structured markup language file by the client 304 from a library of components 310.

Also within the server 301 is a layout manager 311, which uses a parser 312 to read the structured markup language file. In a preferred embodiment, the layout manager is based on XSLT technology which permits the abstraction of layout and style from configuration pages into static pages such that only dynamic content is generated. In the preferred embodiment, all layout and style data resides in one file which is reused for all dynamically created GUIs. This simplifies the process of updating or modifying GUIs because any changes that are made to the one style specification file are applied to all corresponding GUIs. Other style technologies may also be used, such as Struts/Tiles technology. The parser reads the structured markup language file to transform it into a form that can be understood by the computer. In a preferred embodiment, the layout manager uses a parser that is easily integrated with the inventive system, and includes an XML to Java object mapping module. The Apache Jakarta Commons Digester is one example of such a parser. The layout manager 311 applies the style specification file to the structured markup language file to transform one structured markup language file into another structured markup language file, and generate the merged file 307 containing the component and style data. The layout manager may include a script that uses a processor, such as XALAN, to apply the style specification file to the structured markup language file. In some embodiments, the layout manager 311 also updates the global configuration file 309 when reading the structured markup language file. In a preferred embodiment, a script within the layout manager interfaces with the structured markup language file and writes out top-level element attributes to the configuration file for each GUI. Also included within the server are one or more executable applications for generating a customized graphical user interface 313.

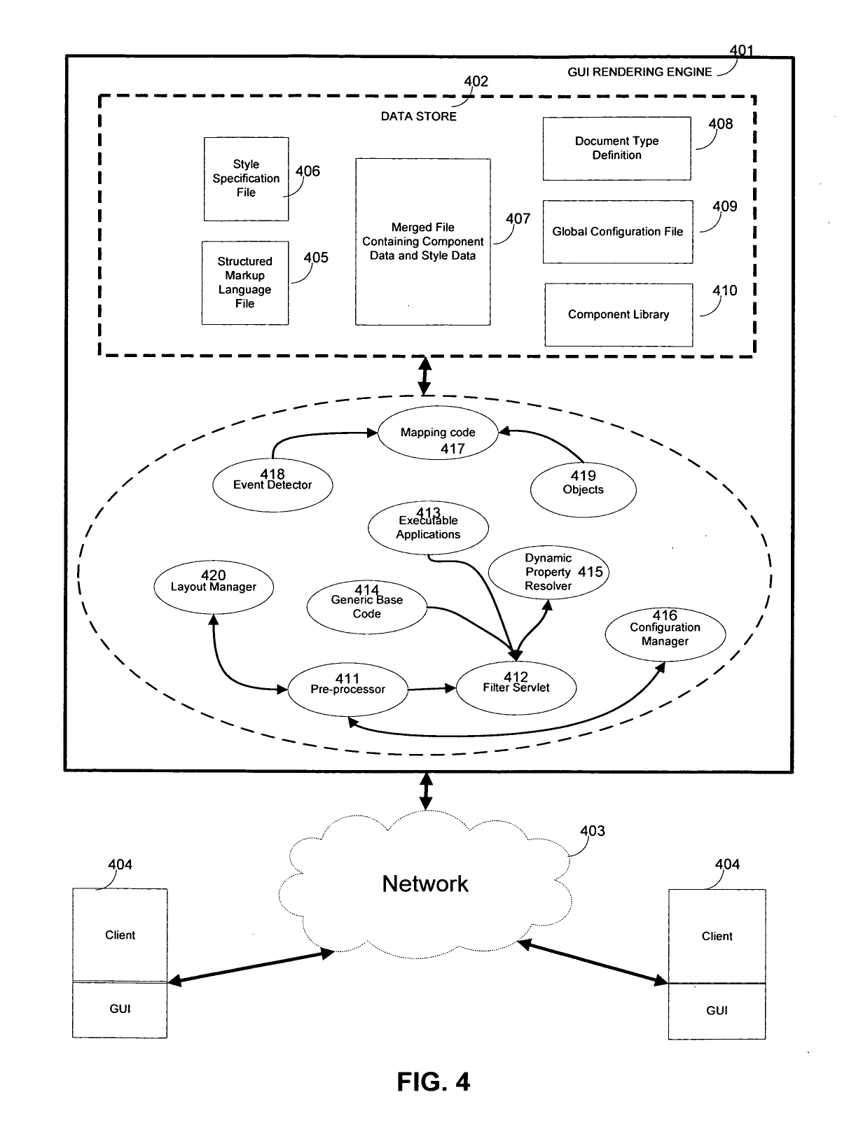

Another embodiment of the present invention is shown with reference to FIG. 4, illustrating a system including certain dynamic aspects of a GUI rendering engine. The system includes a GUI rendering engine 401, a data store 402, a network 403 and one or more clients and GUIs 404. In the embodiment shown in FIG. 4, within the data store 402, as described above, is a structured markup language file 405, a style specification file 406, a merged file containing component data and style data 407, a document type definition 408, a global configuration file 409, and a component library 410. In the preferred embodiment, the GUI rendering engine includes a pre-processor filter 411, a filter servlet 412, and executable applications 413. The pre-processor 411 determines whether a resource in a GUI has previously been requested, such that the associated executable application already exists, as well as whether any web service calls need to be made before the GUI is rendered. If a web service call needs to be made, web service information, such as a list of pull-down options, is gathered for the web service calls and then the calls are made.

Continuing with reference to the system shown in FIG. 4, a client 404 requests a resource from a GUI, and the pre-processor 411 intercepts the filter servlet 412, such as a standard JSF servlet, to determine whether the requested resource has previously been accessed, in which case an existing executable application 413 will be passed to the filter servlet to render the GUI resource. In some embodiments, the executable applications 413 are dynamic beans comprising Java programming code used to render the GUI to the client.

If the application has not previously been accessed, however, the pre-processor 411 initiates conversion of the merged file 407 into one or more automatically generated specialized executable applications 413 to pass to the filter servlet 412 to render the GUI. The specialized executable applications are created using generic base code 414. This avoids the need for a programmer to write specific beans to render a GUI in a particular case. An example of a bean which a programmer would not need to write as a result of using the present invention is in the Appendix hereto (GoogleTestPageBean.java).

In some embodiments, because it may not be known in advance of a GUI resource request what request will be made, and because the specialized executable applications are created dynamically, properties of the specialized executable applications, as well as accessor methods, must be created. The dynamic property resolver plug-in 415 facilitates creation of the properties for the specialized executable applications by identifying those properties which must be created dynamically versus those which are standard, and passing existing properties to the filter servlet. A configuration manager 416 creates specialized executable applications 413 and their properties, using a utility such as the Apache Jakarta Commons Beanutils application based on a global configuration file 409 and the generic base code 414, which may be a base bean class. Some embodiments of the present invention include mapping computer code 417 for associating resource requests with component data, for example, translating an XML file into a populated Java object.

Still referring to FIG. 4, included in the GUI rendering engine is an event detector 418. The event detector facilitates the linking of web service calls to client user-invoked events (e.g., a user clicks a button or link in a GUI). In a preferred embodiment, one method is used to map to one or more components that may be linked to a web service call. This may be accomplished using aspects of products available on the market, such as JSF's ActionEvent model. In a preferred embodiment, a base executable application class is created which implements mapping code to call methods when an event is detected. In some embodiments, web service calls may be associated with components by method name. Also shown is a set of objects 419 which are created when certain elements are encountered in the structured markup language file 405. The creation of the objects facilitates saving information on web service calls for each structured markup language file.

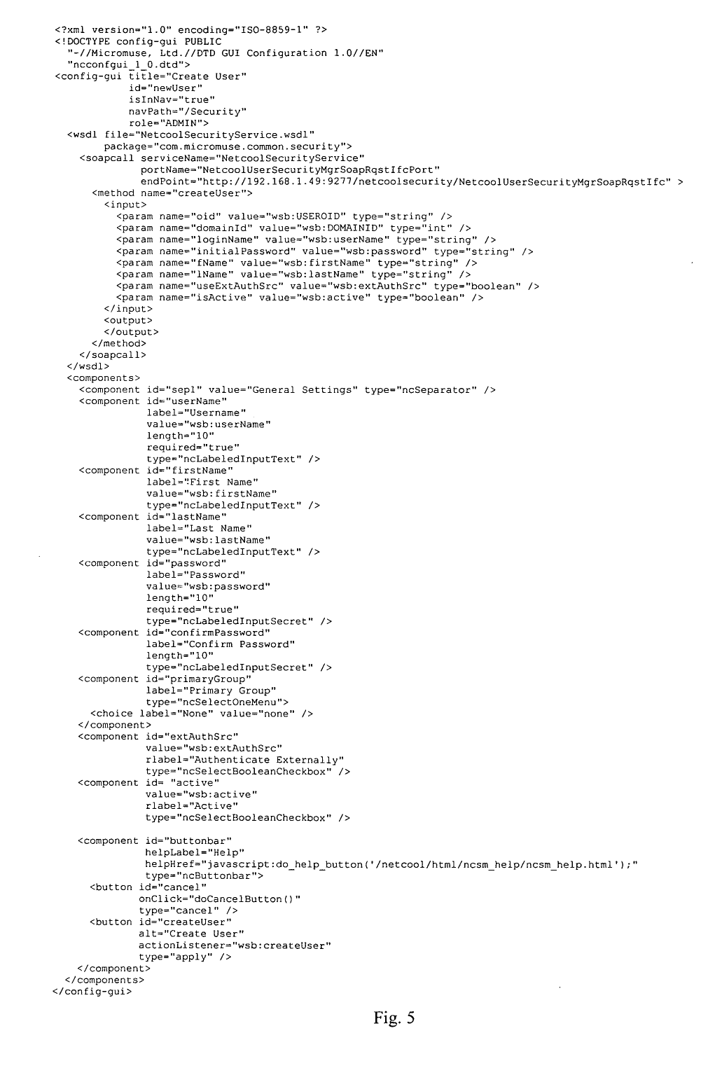

Referring now to FIG. 5, an example of a structured markup language file for use in accordance with one embodiment of the present invention is shown. In a preferred embodiment, a structured markup language file such as illustrated in FIG. 5 is the only file a programmer would need to write using the present invention. Another example of such a file is illustrated in the Appendix hereto (googleTest.xml). In the particular embodiment illustrated with FIG. 5, the structured markup language file is an XML file that a programmer writes to define a web service call to create a user in a specified SecurityManager product and the components associated with the web service call inputs. The XML file contains headers, such as <?xml version=“1.0” encoding=“ISO-8859-1”?> which identifies the document as a version specific XML document and indicates what character set of values is being used in the document to facilitate reading of the document by a parser. In this embodiment, the headers also point to definition data in a document type definition file that includes information needed to render a specific GUI, in this case the config-gui “Create user.” The XML file also contains top level elements, with top level attributes that are used to determine what the GUI will look like (e.g., id=“newUser”). Also in the XML file are web service and component elements. The web service element describes the GUI web service function being accessed and includes a WSDL element (<wsdl file=“NetcoolSecurityService.wsdl” package=“com.micromuse.common.security”>), and a method being invoked (<method name=“createUser”>), among other elements. The XML file also includes component elements that specify the components of the GUI (e.g., text input fields, menus, check boxes and button bars).

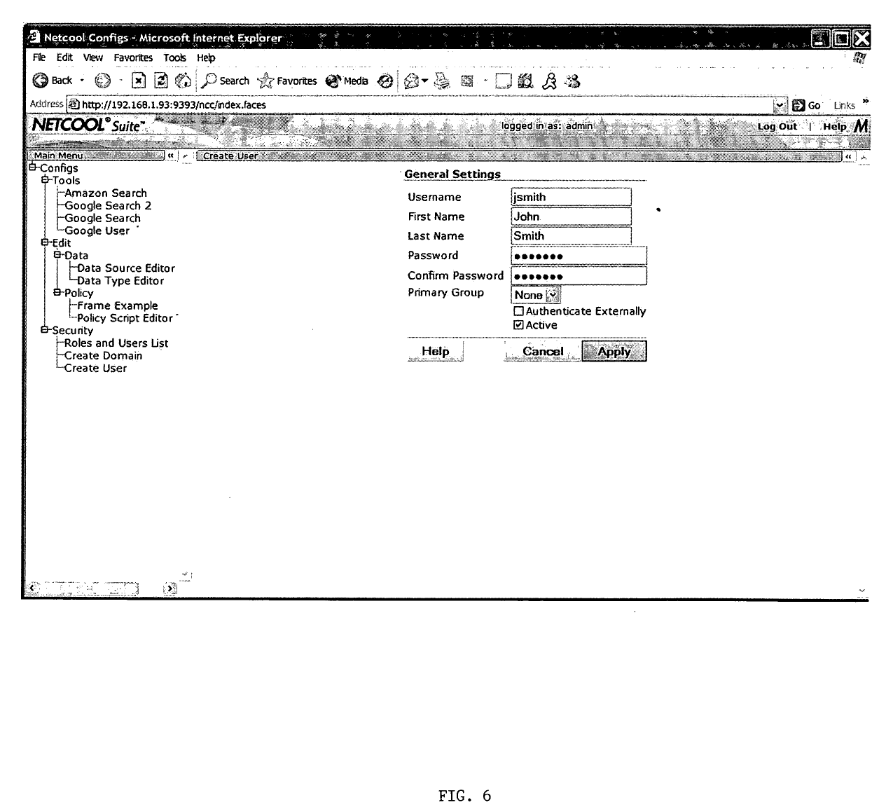

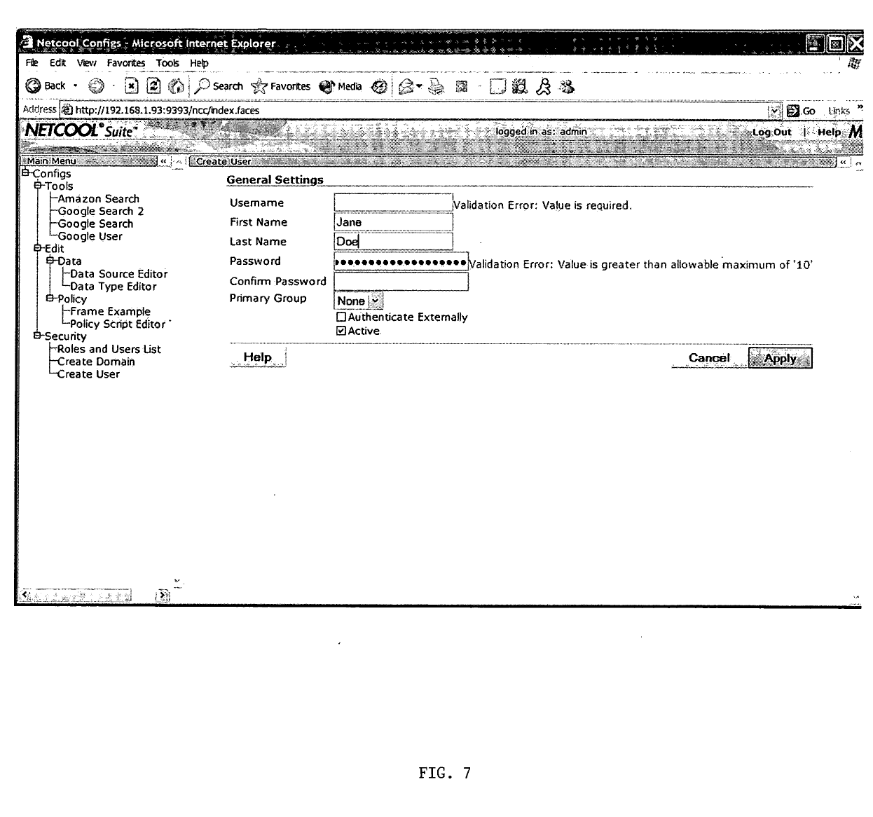

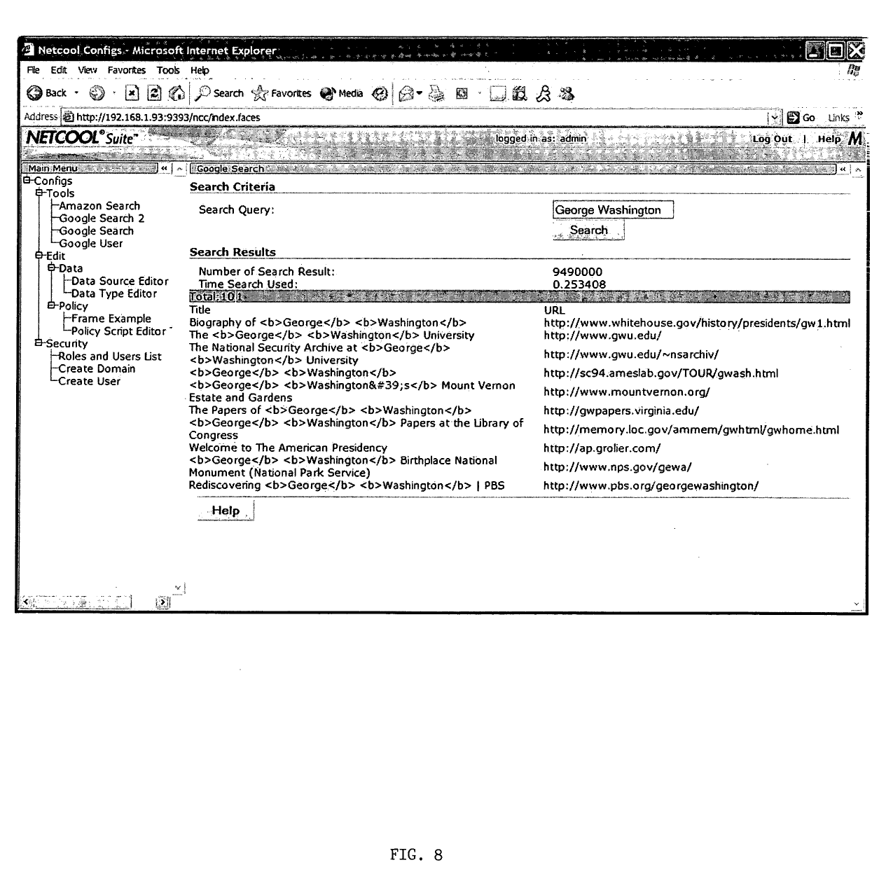

FIGS. 6-8 are examples of GUI screen shots in accordance with certain embodiments of the present invention. FIG. 6 is an example of a screen shot of a GUI generated from the example newUser.xml file of FIG. 5. FIG. 7 is another example of a screen shot of a GUI generated from the example newUser.xml file of FIG. 5, showing use of validation attributes specified in newUser.xml for various input fields. FIG. 8 is an example of a screen shot of a GUI generated from another exemplary structured markup language file, googleTest.xml, in the Appendix hereto.

While the invention has been described and illustrated in connection with preferred embodiments, many variations and modifications as will be evident to those skilled in this art may be made without departing from the spirit and scope of the invention, including for example, use of the method and system in any web services application programming interface and with any object oriented programming language, and the invention is thus not to be limited to the precise details of methodology or construction set forth above as such variations and modification are intended to be included within the scope of the invention.

What is claimed is:

1. A method for generating a customized graphical user interface for specified functions using generic base code, the method comprising:
storing user selected component data associated with the specified functions in one or more structured markup language files;
storing user selected style data in one or more style specification files;
generating a merged file comprising the component data and the style data; and
converting the merged file into one or more executable applications for generating the customized graphical user interface by associating the component data contained in the merged file with generic base code.

2. The method of claim 1, comprising creating definition data which specifies the structure of the one or more structured markup language files.

3. The method of claim 2, wherein creating the definition data comprises creating a document type definition.

4. The method of claim 2, wherein creating the definition data comprises creating an XML schema definition.

5. The method of claim 2, comprising selecting the component data based at least in part on the definition data.

6. The method of claim 1, comprising storing the component data in an XML file.

7. The method of claim 1, comprising storing the style data in an XSLT file.

8. The method of claim 1, comprising modifying the style data in the style specification file to render a different graphical user interface.

9. The method of claim 8, wherein modifying the style data in the style specification file results in corresponding modifications to multiple graphical user interfaces.

10. The method of claim 1, comprising generating the merged filed using at least a converter script and XALAN.

11. The method of claim 10, comprising generating the merged file using the converter script to apply an XSLT file to an XML file using XALAN.

12. The method of claim 1, wherein generating the merged file comprises generating a .jsp file.

13. The method of claim 1, wherein generating the merged file comprises updating a global configuration file.

14. The method of claim 1, wherein the executable application comprises a dynamic bean.

15. The method of claim 1, comprising determining whether to convert the merged file based on access to the customized graphical user interface.

16. The method of claim 15, comprising converting the merged file into the executable application based at least in part on a determination that a resource within the customized graphical user interface has not previously been accessed.

17. The method of claim 1, wherein the executable application is reusable for multiple graphical user interfaces.

18. The method of claim 1, comprising associating an event in the graphical user interface with a web service call.

19. The method of claim 18, comprising associating the event with the web service call by associating the event with a specified component.

20. A computer usable medium storing program code which when executed causes a computer to perform a method for generating a customized graphical user interface for specified functions using generic base code, the method comprising:
storing user selected component data associated with the specified functions in one or more structured markup language files;
storing user selected style data in one or more style specification files;
generating a merged file comprising the component data and the style data; and
converting the merged file into one or more executable applications for generating the customized graphical user interface by associating the component data contained in the merged file with the generic base code.

21. The computer usable medium storing program code of claim 20, comprising causing the computer to create definition data which specifies the structure of the structured markup language file.

22. The computer usable medium storing program code of claim 20, wherein causing the computer to create the definition data comprises creating a document type definition.

23. The computer usable medium storing program code of claim 20, wherein causing the computer to create the definition data comprises creating an XML schema definition.

24. The computer usable medium storing program code of claim 23, comprising causing the computer to select the component data based at least in part on the definition data.

25. The computer usable medium storing program code of claim 20, comprising causing the computer to store the component data in an XML file.

26. The computer usable medium storing program code of claim 20, comprising causing the computer to store the style data in an XSLT file.

27. The computer usable medium storing program code of claim 20, comprising causing the computer to generate the merged filed using at least a converter script and XALAN.

28. The computer usable medium storing program code of claim 20, comprising causing the computer to generate the merged file using the converter script to apply an XSLT file to an XML 5 file using XALAN.

29. The computer usable medium storing program code of claim 20, wherein causing the computer to generate the merged file comprises generating a .jsp file.

30. The computer usable medium storing program code of claim 20, wherein causing the computer to generate the merged file comprises updating a global configuration file.

31. The computer usable medium storing program code of claim 20, wherein the executable application comprises a dynamic bean.

32. The computer usable medium storing program code of claim 20, comprising causing the computer to determine whether to convert the merged file based on access to the customized graphical user interface.

33. The computer usable medium storing program code of claim 20, comprising causing the computer to convert the merged file into the executable application based at least in part on a determination that a resource within the customized graphical user interface has not previously been accessed.

34. The computer usable medium storing program code of claim 20, wherein the executable application is reusable for multiple graphical user interfaces.

35. The computer usable medium storing program code of claim 20, comprising associating an event in the graphical user interface with a web service call.

36. The computer usable medium storing program code of claim 20, comprising associating the event with the web service call by associating the event with a specified component.

37. A system for generating a customized graphical user interface for specified functions represented by pre-defined code, the system comprising:
a structured markup language file for storing user selected component data associated with the specified functions;
a style specification file for storing user selected style data;
a merged file comprising the component data and the style data; and
one or more executable applications for generating the customized graphical user interface by converting the merged file and associating the component data contained in the merged file with the pre-defined code.

1. The system of claim 37, comprising a document type definition for specifying the structure of the structured markup language file.

2. The system of claim 38, wherein the document type definition comprises an XML schema definition.

3. The system of claim 37, wherein the structured markup language file comprises an XML file.

4. The system of claim 37, comprising a library of components for selecting the component data.

5. The system of claim 37, comprising a parser for reading the structured markup language file.

6. The system of claim 37, comprising a style specification file for converting one structured markup language file into another structured markup language file.

7. The system of claim 37, wherein the style specification file comprises an XSLT file.

8. The system of claim 37, comprising a layout manager comprising converter script and XALAN for generating the merged file.

9. The system of claim 37, wherein the merged file comprises a .jsp file.

10. The system of claim 37, comprising a global configuration file updated when the merged file is generated.

11. The system of claim 37, comprising a graphical user interface rendering engine further comprising:
a filter servlet for determining whether a resource has previously been accessed;
a dynamic property generator for generating the properties of the executable application;
a dynamic property resolver for passing existing properties and using a generic executable application to convert the merged file into a specialized executable application; and
mapping computer code for associating resource requests with component data.

12. The system of claim 37, wherein the executable application comprises a bean.

13. The system of claim 37, wherein the executable application comprises Java programming code.

14. The system of claim 37, comprising a processor for determining whether to convert the merged file based on access to the customized graphical user interface.

15. The system of claim 37, comprising a processor for converting the merged file into the executable application based at least in part on a determination that a resource within the customized graphical user interface has not previously been accessed.

16. The system of claim 37, wherein the one or more executable applications are reusable for multiple graphical user interfaces.

17. The system of claim 37, comprising an application for associating an event in the graphical user interface with a web service call.

18. The system of claim 37, comprising an application for associating the event with the web service call by associating the event with a specified component.
